(19) United States
(12) Patent Application Publication
(10) Pub. No.: US 2008/0108029 A1
(43) Pub. Date: May 8, 2008

(54) PERSONALIZED EARLY LEARNING SYSTEMS AND METHODS

(76) Inventors: Lori Abert Luke, North Salt Lake, UT (US); Lynette Marie Frenette, North Salt Lake, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/557,067

(22) Filed: Nov. 6, 2006

(51) Int. Cl. G09B 17/00

(52) U.S. Cl. 434/178

(57) ABSTRACT

Personalized reading materials are created and used to promote reading literacy in young readers. The personalized reading materials, which can be created through computer interfaces, include words to be learned, as well as personalized images of the child learning the words. The child is then repeatedly exposed to the learning materials, which can include, among other things, combinations of labels, flashcards, reading books, workbooks and so forth.

### CROSS-REFERENCE TO RELATED APPLICATIONS

N/A

### BACKGROUND

1. Field of the Invention

The present invention relates to educational systems and methods and, even more particularly, to educational systems and methods for promoting reading literacy.

2. Background and Relevant Art

There are several educational philosophies directed towards the acquisition and refinement of reading skills. One of the most popular is Phonics, a system that emphasizes the memorization of the sounds of individual letters and disparate letter combinations. While Phonics has clearly proven to be an effective tool for helping some early readers learn how to read, however, Phonics is not universally effective for all readers. In fact, as noted by the International Reading Association and other interested parties, no single system or method provides a universal answer for effectively teaching all reading skills. One reason for this is that reading is a very complex and multifaceted activity. Another reason is that individual readers learn and respond to instructions in different ways.

To accommodate for the known diversity in the learning capacities and at preferences of different readers, reading research is continually being done and teaching systems are being developed and applied on an on-going basis. One approach that has been developed for the teaching of reading is the Whole-Word approach.

Like Phonics, the Whole-Word approach has also proven itself as a successful tool in teaching reading literacy. Contrary to Phonics, however, the Whole-Word approach places a strong emphasis on learning words as whole units, rather than individual syllables or sub-word parts, thereby teaching readers to recognize and sight read whole words, rather than having to sound out each word.

The Whole-Word approach may be the best approach for some children. It has been found that children who tend to have visual-spatial, tactile, and global reading styles will particularly benefit from this type of reading instruction. While this method may not completely develop the reading skills of some children, most children will nonetheless benefit from the repeated exposure to words resulting from the Whole-Word approach.

Notably, it is important within the Whole-Word approach and virtually every other early learning literacy program for readers and, particularly, early readers to create cognitive associations between the textual representations of words and the actual meanings of each word. These critical associations are introduced and reinforced within the Whole-Word approach by repeatedly exposing the readers to the words in meaningful contexts. The Whole-Word approach is particularly beneficial in this regard inasmuch as readers can focus on word associations without having to consciously dissect and interpret the disparate parts of each word.

The repetitive exposure to words being learned through the Whole-Word approach and other approaches, however, can become a very tedious and boring endeavor for readers, particularly young readers who can easily become disinterested and discouraged.

To help maintain the attention of a reader and to further facilitate the recognition and remembrance of word associations, abstract pictures are sometimes presented along with the textual representations of the words being learned. For example, a reading flashcard might include an abstract picture of a ball along with the textual representation of the word “BALL”. Another flashcard might include the word “RED” with abstract pictures of red crayons, wagons, or other objects colored red. In yet other examples, some flashcards include printed numbers along with pictures reflecting a corresponding number of objects.

It should be noted, in this regard, that while the use of pictures has been found to help increase the attention of some readers and to suggest intended associations between textual representations of words and their actual meanings, the use of abstract images fails to guarantee that the intended association between the textual representation of a word and the actual meaning of the word will be conveyed in such a way that it will be recognized and learned by the reader or that the reader will necessarily be engaged with the desired level of interest.

The foregoing assertions are particularly true in situations where the abstract pictures reflect images that are ethnically, socially, economically or otherwise demographically diverse from the objects and experiences familiar to the reader.

Consider, for example, a flashcard presenting the term “HAT” along with an image of a person sitting on a horse with a cowboy hat in the person's hand. The image presented with the term “HAT” might not have the desired effect of engaging the interest of a child having an ethnicity, age or gender that is quite different than that of the person in the image.

In the foregoing example, the ability of the child to recognize the intended association between the term “HAT” and the image (of the person holding the cowboy hat) can also be hindered when the child comes from an environment where hats are of a completely different shape and style than cowboy hats. In such instances, it is possible and even likely that a very young child will create an incorrect contextual association for the term “HAT”, such as that of a cowboy, horse or other meaning that the child interprets from images in the picture and based upon the child's experiences.

In yet another example, a flashcard presenting the term “TOY” or “RED” along with a picture of a toy wagon, a car or another abstract toy can inadvertently create the wrong association between the word being learned and the object shown in the picture. Very young and early readers are particularly susceptible to such confusion.

In view of the foregoing, there is currently a need for improved educational methods and systems for teaching reading literacy, particularly to young children. This need also extends to methods and systems that can be used to help improve the manner in which associations between words and their corresponding textual representations are created and reinforced. There is also a need to increase the level of interest of young readers, particularly those that are learning to read with Whole-Word educational systems and materials.

Despite the foregoing examples and problems noted with existing systems and the current needs in the industry, it will be appreciated that this background is only provided to illustrate exemplary areas where some embodiments of the invention might be practiced. As such, it will also be appreciated that that the subject matter claimed within this application is not limited to any specific embodiments that necessarily solve any of the foregoing disadvantages or that operate only in environments such as those described above.

### BRIEF SUMMARY

Many of the embodiments described in this application are directed towards methods and systems for promoting reading literacy in young readers. In one such embodiment, reading literacy is promoted through the personalization of Whole-Word learning materials, such as, but not limited to, combinations of flashcards, labels, reading books, workbooks, templates and software applications.

In some instances, the reading materials, such as those referenced above, are accessed and developed through a computerized interface that provides a list of one or more different combinations of learning materials to be personalized. Within some of the computerized interface embodiments, a user is able to view and select a package of one or more different learning materials to be personalized. Once the initial selection of learning materials is made, a predetermined list of words, objects, activities or other elements to be taught is presented for user selection.

According to some embodiments, the predetermined list comprises a list of words corresponding to a particular theme, such as primer words to be learned by young readers or other themes corresponding to colors, numbers, particular environments, or other themes. It is also possible, in some embodiments, for the user to edit the predetermined list of words or to create a custom list of words that is different than the predetermined list of words.

The user is also prompted for and/or provides personalized images corresponding to the list of words. According to some embodiments, the personalized images comprise photographs or drawings that include the early reader for whom the materials are being customized, with the objects, environments, activities or conditions that each of the selected words contextually applies to. In some instances, the images include drawings prepared by the early reader and that are easily recognized by the early reader as corresponding to words in the list of words.

Thereafter, based upon the previous selections of words and images, the learning materials are published or otherwise assembled and personalized by combining the supplied images and the selected words into learning materials that the early reader will be repeatedly exposed to. Because the learning materials include images of and/or by the child, the child is likely to experience an increased interest and desire to repeatedly view the learning materials, as compared to learning materials only containing abstract pictures. The repeated exposure to the learning materials can also help develop and reinforce early reading skills and cognitive associations between words and their meanings.

It will be appreciated that the learning materials can be assembled by a remote third party, after being personalized, but prior to the customer receiving the published learning materials, or in some alternative embodiments, the customer can also personalize the learning materials subsequent to the purchase of templates and other learning materials that are ready for personalization. In some embodiments, for example, printed educational materials are prepared with the text of predetermined words in a template format with predetermined spaces for the insertion of personalized images that include the reader and/or that are made by the reader and that convey meanings recognized by the reader as corresponding to the particular words.

The templates or kits prepared for subsequent customization can also be made available in electronic form, rather than only printed form, so that they can be electronically edited on a computing system and displayed and/or printed for use after the appropriate images are provided and attached to the template materials.

It will be appreciated that the foregoing Summary is not intended to identify any particular key features or essential features of the claimed subject matter, nor is it intended to be used as an aid in determining the scope of the claimed subject matter provided to introduce a selection of concepts in a simplified form that are further described below in the Detailed Description.

Accordingly, some additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a flowchart of acts that can be executed in the performance of some of the methods of the invention for preparing and using personalized learning materials;

FIG. 2 illustrates another flowchart of acts that can be executed in the performance of some of the methods of the invention for preparing and using personalized learning materials through a computer interface;

FIG. 3 illustrates one embodiment of a computer network through which at least some of the personalized learning materials of the invention can be accessed, prepared and/or used;

FIGS. 4A-4E illustrate various non-limiting examples of learning materials falling within the scope of the present invention.

### DETAILED DESCRIPTION

Many of the embodiments described in this application are directed towards the promotion of reading literacy in young readers, such as, but not limited to 3 year olds to 6 year olds. In some embodiments, reading literacy is promoted through the creation and use of personalized reading materials that include images created by and/or that incorporate the young reader who is learning to read. The reading materials that are personalized include, but are not limited to, any combination of flashcards, labels, reading books, workbooks, templates and software applications.

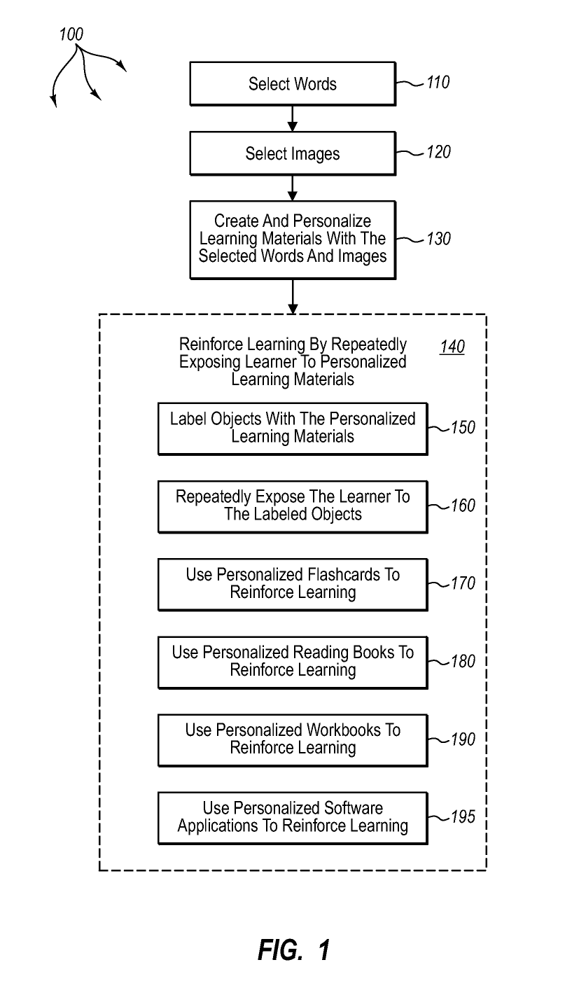

Attention will now be directed to FIG. 1, which illustrates a flowchart 100 of various acts for creating and using personalized learning materials according to one embodiment of the invention. As shown, the first illustrated act is an act of selecting and/or providing words to be taught to or learned by an early reader (act 110). It will be appreciated that any number of words can be selected during this process. Different types of words can also be selected, as described below, in including printed text words (in any language), as well as conceptual words or concepts.

The act of selecting words to be taught or learned (act 110) can be initiated by a parent, teacher or any other caregiver, for example, in response to identifying particular words a child needs to learn. In some instances, the list of words selected or built is unique from child to child. By enabling the caregiver to individually select the words to be learned according to the needs and interests of a particular child or a group of children, it is possible for very different and unique lists of words to be selected.

In some alternative embodiments, predetermined lists of words can also be pre-selected by a third party provider, such as, but not limited to experts in the fields of childhood development, literacy, and early education. These embodiments, for example, can be useful for leveraging the knowledge and expertise of educators and other experts who know what types of words are the most appropriate or beneficial for a child to learn according to an age, developmental stage or experience level of a child.

In some embodiments, the selections of words (act 110) can include a consumer selecting a subset of a predetermined list of words and/or customizing the predetermined list of words by substituting certain words for other words already in the predetermined list according to need or interest.

It will be appreciated that the selection of words can be made through any combination of oral communication (e.g., over the phone), paper communication (e.g., the mail) and/or any type of computer interface.

The next illustrated act in the flowchart 100 is the act of selecting and/or providing images (act 120). This act can also be executed, as appropriate, through various lines of communication. In some instances, for example, a customer selects images and submits the images in an electronic form through a computer interface. In other instances, the images are submitted in either a printed form or an electronic form through the mail to an appropriate party responsible for creating the personalized learning materials.

It will be appreciated that when the images are gathered or submitted in an electronic form, the act of selecting images (act 120) also includes scanning, copying or otherwise downloading the images.

The images that are selected can be any type of image format. The images can also include any combination of photographs and drawings. In fact, according to some embodiments described below, in which the learning materials are applied in a teaching environment through a computerized interface, the images can also include video and/or audio files that are played on the computerized interface.

According to the preferred embodiments of the invention, the images correspond directly to the selected words and include at least a representation of the child who is being taught the selected words. In some embodiments, for example, the images include, for each word in the list of words, a separate photograph of the child along with an object or experiencing something associated with each of the words. In other embodiments, some of the images include drawings that incorporate the child or that are made by the child. Any combination of drawings and photographs can also be used.

After the images and words are selected, learning materials are personalized and created with the selected words and images (act 130). These personalized learning materials can include, but are not limited to, any combination of flashcards, labels, reading books, workbooks, templates and software applications.

The actual assembly and publication of the personalized learning materials (act 130) can be commissioned and performed by a third party and/or automatically implemented through the use of computing systems. In some instances the creation of the personalized learning materials (act 130) can also be performed by the consumer when the consumer acquires templates for labels, flashcards, books and other materials that have designated spaces for images corresponding to particular words on the templates. The consumer then assembles the materials by attaching the appropriate images to the templates.

Regardless of the manner in which the personalized learning materials were created the child is repeatedly exposed to the learning materials (step 140). It will be noted that the repeated exposure of the learning materials to the child promotes the learning of reading literacy, particularly with the Whole-Word approach. The use of the personalized learning materials that include the images of the child, as described herein, can also help foster the development of correct cognitive associations between the words and the word meanings and, at the same time, captivate the interest of the child.

The functional step of repeatedly exposing the child to the personalized learning materials (step 140) can include various corresponding acts, such as the creation and use of personalized labels (acts 150 and 160), flashcards (act 170), reading books (act 180), workbooks (190), and software applications (such as games and visual interfaces that render words and images) (195).

In one embodiment, personalized labels (including both a word and the corresponding personalized child image) are affixed to, placed on or next to objects corresponding to the words. For example, a label for the term “TABLE” can be affixed to or placed on a table.

It will be noted that because the label includes both the image and the word, it is unlikely that the child will create the wrong association between the word and another object that is placed near the label. The advantages of using personalized learning materials, such as personalized labels, in this manner should be readily apparent in view of prior art labeling techniques. For example, it will be apparent that a child will be more engaged and interested in labels that include personalized child images, rather than labels that only include printed text or abstract images. Furthermore, the use of personalized images that include the child along with objects familiar to the child can help minimize the risk that the child will create the wrong association between the word and the object.

The foregoing is particularly apparent when considering situations in which the object is mobile (e.g., a cat or dog) and the label needs to be put in a location associated with the object (e.g., a food bowl, or litter), but not on the object. With existing systems, a standard (printed text only) label might create the wrong association in the mind of the child (e.g., CAT=BOWL). In contrast, the inventive personalizing method of the present embodiment, which includes personalizing of the learning label with both the word and an image of the child with the object, fosters the creation of a correct association between the printed text of the word and the true meaning of the word.

As mentioned above, it is desirable that the child is repeatedly exposed to the learning materials. Accordingly, it is sometimes helpful to reinforce the learning through the use of various combinations of the learning materials described herein.

All of the learning materials are preferably personalized with images of or by the child and that are associated with the words being learned, as described above in reference to the personalized labels. According to some embodiments, all of the different types of learning materials include a same set of words and corresponding images. For instance, a kit of learning materials that includes labels, flashcards and booklets will all include the same images and the same keywords.

Notwithstanding the foregoing example, it will be appreciated, that the scope of the invention is not limited to the creation and use of any particular set or package of learning materials. In particular, the invention also extends to the creation and use of other packages of learning materials. Some of the other non-limiting examples of learning material packages include a package that includes only labels, flashcards, books, booklets, workbooks, or software applications; packages that include labels and flashcards; packages that include labels, flashcards, books and workbooks; combinations of the foregoing and so forth.

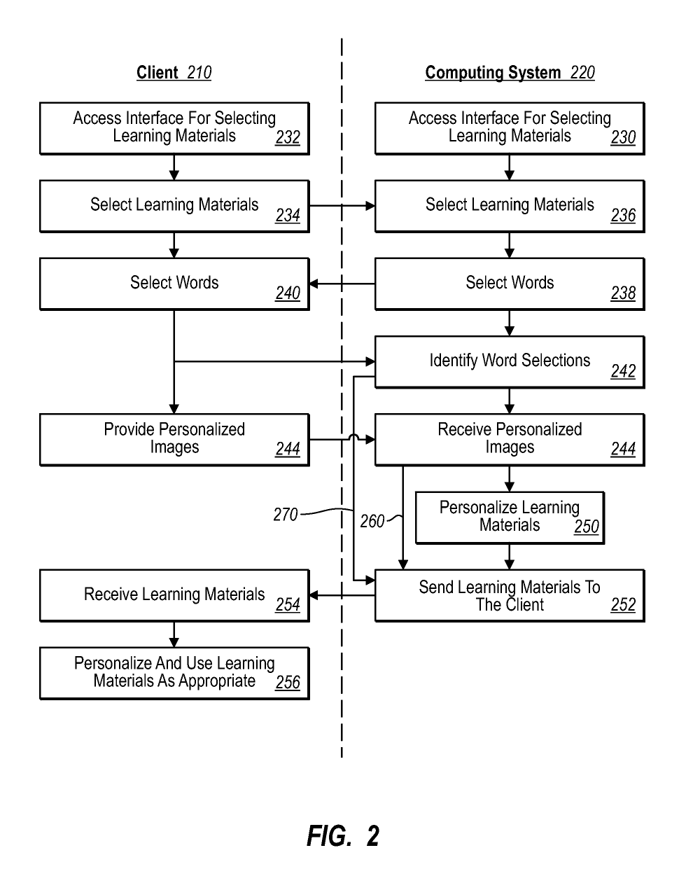

As mentioned above, the personalized learning materials can be assembled and/or modified by a third party and/or by the consumer. In some embodiments, the personalized learning materials can also be created and/or modified through a computer interface. FIG. 2 illustrates a flowchart 200 of one non-limiting embodiment for creating personalized learning materials with the use of a computing system through a computing interface.

As shown in FIG. 2, a client 210 communicates with a computing system 220, through a computing interface, to identify and personalize learning materials. Within this embodiment, the client 210 should be broadly defined as any client, including any combination of human consumers and computing devices, with access to the computing system 220. Correspondingly, the computing system 220 can include any combination of standalone or networked computing system and/or business operation that is capable of providing the services described herein.

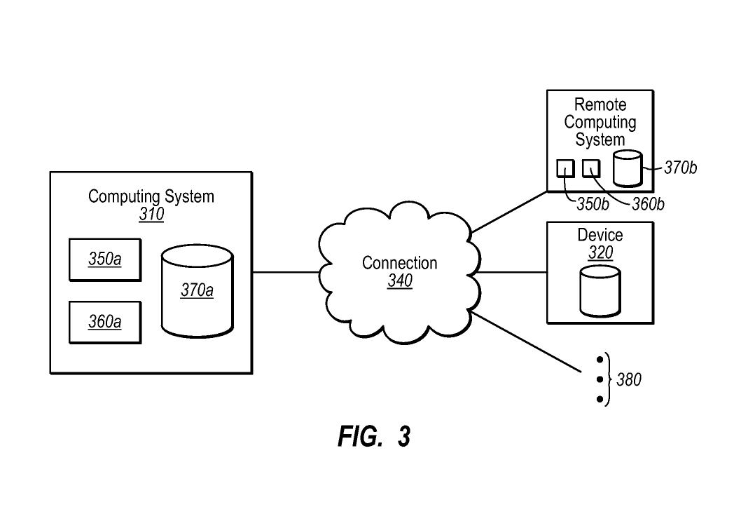

In order to provide a better understanding of the various types of computing systems that can be used within the embodiments described in at least FIG. 2, one example of a computing environment will now be described in reference to FIG. 3.

As shown in FIG. 3, a first computing system 310, which could be included within either of the client 210 or computing system 220, referenced above, in FIG. 2, is connected to one or more other devices 320 or computing systems 330. The other devices 320 can include, but are not limited to printers, cameras, PDAs, and so forth. The remote computing system 320 can include servers and other computing systems providing services or data to the computing system 310. The connection 340 between the various systems and devices can be wired, wireless, the Internet, LAN, WAN, and any other type of connection. Although only one remote computing system 320 and only one other device are shown to be connectable to the computing system 320, it will be appreciated that any number and variety of other devices and systems can be connected to the computing system, as suggested by the ellipses 380.

As further shown, the computing systems 310 and 320 include sufficient computing modules 350 and interfaces 360 for providing the functionality described in this application, and as would be appreciated by those of ordinary skill in the art. The computing systems 350 and 360 and the other devices 330 also include adequate storage 370 for storing the data (e.g., images, text, templates, and so forth) used to create the personalized learning materials described in this application, as appropriate.

Now, returning to FIG. 2, it is noted that an appropriate computing system 220 provides access to learning materials (act 230), such as those described above through computing interfaces and, in some instances, with the assistance of human operators. Accordingly to some embodiments, the computing system 220 displays or otherwise (e.g., audibly) provides various individual types of learning materials and/or packages of learning materials that can be selected for personalization.

Once a client accesses the learning materials 232, they are able to select one or more of the learning material types or packages to be customized (act 234). Thereafter, once the computing system 220 receives a selection of the learning materials (act 236), a list of words is provided (act 238) for client selection (act 240), for which the learning materials are to be customized. Alternatively, the list of words is provided by the client 210 to the computing system 220. As suggested above, the client 210 can also modify the list provided by the computing system 220. Either way, the word selections are made and/or received in such a way that the computing system is able to identify the appropriate word selections (act 242).

The client 210 also provides personalized child images (photographs of the child or drawings incorporating the child or drawings made by the child) to the computing system 220 (act 244). The client 210 may be prompted for the images or may provide the images without being prompted.

Preferably, the computing system 220 is appraised of which images correspond to each of the selected words. This can be done, for example, by submitting one image at a time for each word, as prompted, or by submitting the images in the same order that the words are listed. In other embodiments, interfaces can be provided that show the words with a space for typing in or otherwise identifying which image corresponds to each word. Other interfaces can also be provided for enabling the client 210 to drag and drop images onto corresponding word UI objects. Human operator interaction and discretion can also be used to associate the images with the corresponding words.

Thereafter, once the computing system 220 receives the personalized images, and word selections, the computing system personalizes the selected learning materials by merging the selected words and the corresponding submitted images into the appropriate learning materials (act 250). The personalized learning materials are then sent to the client or an address designated by the client (act 252). In some embodiments, some of the personalized learning materials are stored at the computing system 220 for on-line use or for subsequent retrieval.

Typically, the computing system 200 provides the learning materials in an assembled and published format that includes the words and images printed on the learning materials. In some alternative embodiments, as reflected by arrows 260 and 270, the computing system 220 can also provide materials to the client 210 without assembling them. In fact, as shown by arrow 260, it is also possible for the computing system to send out the learning materials for assembly by the client 210, and without even receiving the personalized images that will ultimately be attached to the learning materials by the client 210 at a later time. In these instances, the learning materials are sent out in a published template format and the client, upon receiving the materials (act 254) assembles and personalizes the learning materials (act 256).

In embodiments where the learning materials include software, it is also possible for the software to be prepared and sold with encoded word lists and templates that the client 210 can select and print out. The templates and word lists can also be customized and modified by the client. In some embodiments, the software enables images to be attached to the learning materials prior to printing the learning materials. In other embodiments, the templates are printed with the selected keywords before images are attached to the learning materials. The software learning materials can also include interactive games and other display screens, as described below, to be used as a teaching tool.

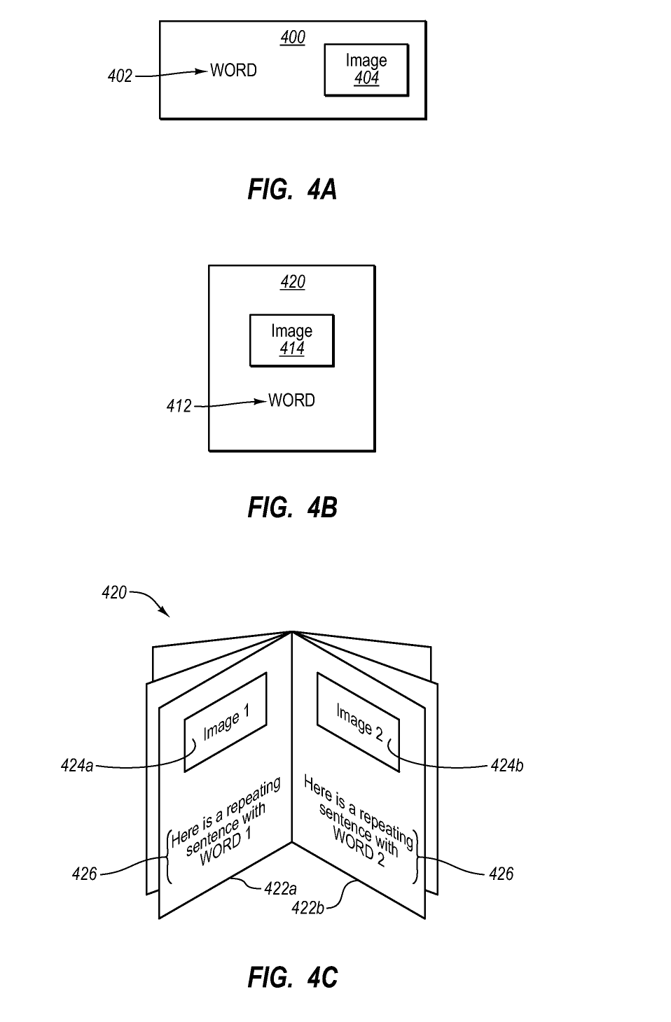

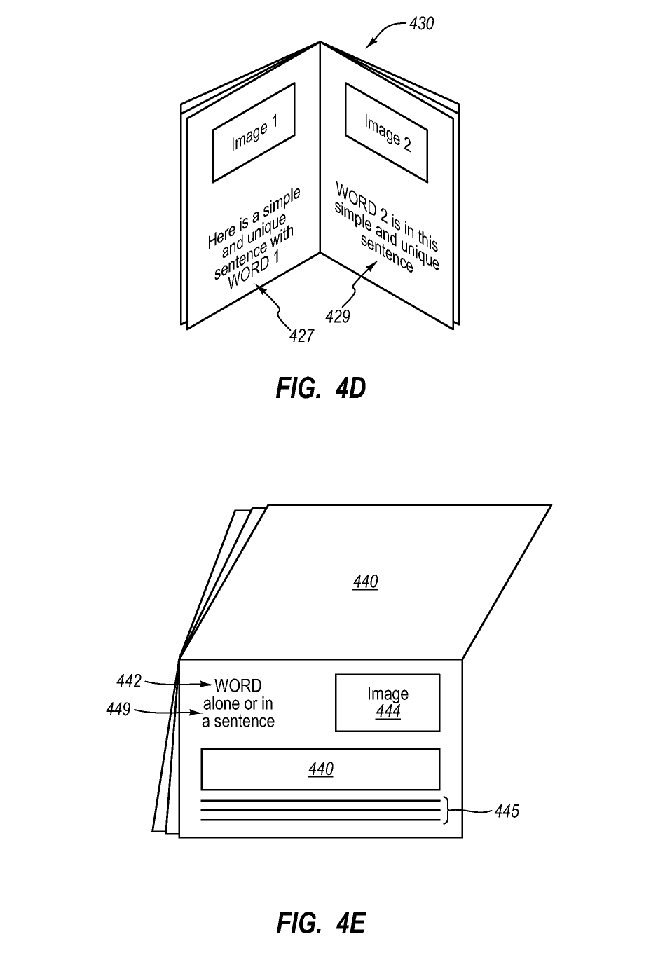

Attention will now be directed to FIGS. 4A-4E, which illustrate various non-limiting examples of personalized learning materials that can be manufactured according to any of the foregoing methods.

FIG. 4A, for example, illustrates one embodiment of a label 400 that can be prepared and assembled by a remote third party or that can be printed out in a template form for subsequent assembly. As shown, the label 400 includes a word 402 that has been selected and that is printed on the label next to an image 404.

In some embodiments, the image 404 is a personalized image selected by the customer and that is printed on the label 400. In other embodiments, the image 404 is an abstract image or place filler provided as a template for the placement of a personalized image at a later time. Although not necessary, the label can be self-adhesive, to facilitate labeling of objects. Similarly, for the template type embodiments, the image 404 may include a removable laminate placed over an adhesive portion of the label 404 that can be used to secure a personalized image over the image portion 404 when the laminate is removed. In some embodiments, such as these, the personalized image includes a face or body of the child that overlays an existing abstract and default image. Accordingly, it is possible for the personalized image to entirely obstruct the designated image location in the learning materials or to only obstruct a portion of the designated image location and to be incorporated with other images on the learning materials.

It will be appreciated that the remaining learning materials, including the flashcard 410 in FIG. 4B, the books or booklets 420 and 430 in FIGS. 4C and 4D, and the workbook 440 in FIG. 4E can also be manufactured similarly to the label 400 in FIG. 4A, including all of the features and functionality described in reference to the label 400, particularly with regard to image incorporation and placement. Notably, however, there are some differences between the label 400 and the remaining learning materials, which will now be described.

While the flashcard 410 shown in FIG. 4B is similar to the label 400 of FIG. 4A, it will be noted that the shape, size and layout of the flashcard 410 is slightly different than that of the label 400. In some instances, the size and shape of the labels 400 is functionally designed to facilitate placement of the labels on other objects, while the size and shape of the flashcards 410 is dictated by ergonomic factors to facilitate handling without obstructing view of the image 414 and the word 412. Notwithstanding these differences, however, it will be appreciated that the size and layout of the flashcard 410 and label 400 can have virtually any size and configuration to accommodate a broad range of needs and preferences.

The book 420 in FIG. 4C includes several pages of word and image combinations that have been combined into a single book 420. Preferably, although not necessarily, the book includes every word and image combination provided in the labels and/or flashcards that are acquired with the book and that have been created according to the embodiments of the invention. Only two pages of the book 420 are shown in detail. One page includes a first combination of a word 422a and a corresponding image 424a, while the opposite page has a different word 422b and image 424b combination. Each of the pages also includes a repeating sentence 426. The repeating sentence 426, which is printed on a plurality of pages, alternately incorporates each of the words 422a and 422b in the book. Accordingly, the repeating sentence is not exactly the same, inasmuch as the words 422a and 422b are alternately used. However, according to some embodiments, the only change to the repeating sentence 426 is the alternating use of the keywords, 422a and 422b, for example.

The use of the repeating sentence is a good way for a child to become familiar with simple sentence structures and to distinguish and recognize how the words they are learning fit within a common sentence structure. The actual repeating sentence that is used (e.g., “My home has a KEYWORD.”) can be predetermined or selected, created and/or modified by the client and/or computing system to accommodate virtually any need and preference.

Although the keywords (442a and 442b) are located at the end of the sentence in the present examples, it will be appreciated that the keywords can also be incorporated into different parts of the sentence structure, including the beginning and middle of the sentence. In fact, the keywords can also be incorporated numerous times in each sentence as well, even though they are only shown to be used once in the present example.

The book 430 shown in FIG. 4D is similar to the book 420 of FIG. 4C, except that the sentences 427 and 429 used in book 430 are unique and vary by more than only the alternating use of the keywords. The skills required to read and recognize different sentences in this book 430 are more advanced than those required to read book 420. The increased difficulty experienced from reading the labels, the flashcards, and the two types of books are designed to enable a child to progressively improve their reading skills. This progression can also continue with the use of the workbooks described below.

Notwithstanding the differences between the various learning materials, the image and words sets remain the same, according to most, but not all, embodiments. For example, the images and words used in book 420 are the same as those used in book 430. This similarity is beneficial for facilitating the recognition of word associations and for reinforcing the learning that has already taken place (e.g., with the other book 420 and the flashcards 410 and labels 400). The use of the images, particularly the personalized images, also helps to maintain the child's interest.

As a child develops reading and literacy skills, it is important for the child to learn to write and communicate their understanding. The workbook 440 is specifically designed with this goal in mind. In particular, the workbook 440 includes one or more designated spaces for receiving the writings and drawings of the child learning the words and that correspond to the words being learned. For example the child can draw a picture and practice writing the word alone or in a sentence.

In the present embodiment, two different writing spaces are provided, including a drawing space 443 and a lined writing space 445. It will be appreciated, however, that other combinations of writing and drawing spaces can also be provided and in a different layout than that shown.

According to some embodiments, the drawing and/or writing spaces are provided in a visually proximate location to the word being learned and the corresponding personalized image 444. In other words, the word being learned 442 and the image 444 should be visible, or at least readily accessible to the child for the child's reference, when the child is working within the writing spaces 443 and 445.

FIG. 4E, element 449, also indicates that it is possible for the workbook 440 to be printed with the selected words as stand-alone words or within sentences, such as the sentences described above in reference to books 420 and 430.

Although not shown, it will be appreciated by those of skill in the art that the present invention also extends to embodiments in which the learning materials comprise software applications that include display screens showing both the keywords, along with their corresponding personalized images. In some instances, the software applications include displays that essentially duplicate, in electronic form, the labels, flashcards, books and workbooks described above.

The software applications can also include interactive games, workspaces and other interfaces that are different than the labels, flashcards, books and workbooks described above, and that can still be used to reinforce learning of the selected keywords. The software applications can be installed and used on virtually any type of computing device.

In summary, there are various types and configurations of learning materials that can be personalized and used within the scope of the present invention.

Although many of the foregoing examples described throughout the application apply specifically to the personalization of Whole-Word reading materials, it will be appreciated that the invention also extends to other embodiments in which reading materials, such as Phonic reading materials and other reading materials other than Whole-Word reading materials are personalized, such as, but not limited to reading materials teaching specific letters, partial words, or concepts.

Furthermore, although many examples have been provided with regard to learning to read printed words, it will be appreciated that the scope of the invention also extends to embodiments in which other words are learned rather than only printed words. For example, conceptual words that include such things as symbols, seasons, colors, letters, emotions, activities and many other types of things can be represented by visual images that include the personalized images of the child learning those conceptual words or things. The scope of the invention also extends to these types of embodiments.

In embodiments where the child is learning conceptual words or concepts, the selection and incorporation of printed words is replaced by the selection and incorporation of symbols or images represented said concepts. For example, a palette of colors can be provided for selection and the color will be incorporated into the learning materials along with a picture of the child. Similarly, a selection of pictures representing an activity, season or emotion can be presented for selection and modification and which is assembled with an image of the child experiencing or participating in the activity, emotion or season. Letters and letter combinations can also be printed with an image of the child, either alone or with an object that corresponds to the letter (e.g., the letter A can be selected and printed with a picture of the child with an apple).

Even though the thing being learned may not be exactly represented within the picture, the use of the personalized image can still help create the correct cognitive association when the picture includes images familiar to the child. Furthermore, the image of the child can help maintain a high level of interest.

Finally, and as described above, various embodiments of the invention can include computing systems comprising special purpose or general-purpose computers, as well as the various computer hardware and software incorporated within or accessed by the computing system. Accordingly, it will be appreciated that various embodiments of the invention also include computer-readable media for carrying or having computer-executable instructions or data structures stored thereon. Such computer-readable media can be any available media that can be accessed by a general purpose or special purpose computer.

By way of example, and not limitation, computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer.

Furthermore, when information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

As defined herein, computer-executable instructions should be broadly construed as any computer-readable instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Accordingly, it will be appreciated that the present invention may be embodied in other specific forms without departing from its spirit or essential characteristics and that the described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for personalizing and using learning materials to promote reading literacy, the method comprising:
selecting words to be learned by a child;
for each of the selected words, identifying personalized images of the child that directly correspond to the selected words;
creating learning materials that include the selected words and corresponding personalized images of the child that corresponds directly to the selected words, respectively; and
repeatedly exposing the child to the learning materials containing the selected words and the personalized images of the child to reinforce learning of at least the selected words by the child.

2. A method as recited in claim 1, wherein the learning materials include labels, and wherein the method further includes labeling objects or placing labels next to objects associated with the selected words and in such a way that the selected words are visible along with the personalized images of the child corresponding to the selected word.

3. A method as recited in claim 1, wherein the learning materials include both labels and flashcards, and wherein the method includes selecting a package of learning materials to be personalized that includes the labels and the flashcards and wherein the flashcards and the labels include a same set of personalized images of the child and corresponding selected words.

4. A method as recited in claim 1, wherein the learning materials include labels, flashcards and a reading book, and wherein the method includes selecting a package of learning materials to be personalized that includes the labels, flashcards and the reading book and wherein the flashcards, the labels and the reading book include a same set of personalized images of the child and corresponding selected words.

5. A method as recited in claim 4, wherein the reading book includes a sentence that is repeatedly printed in the book and that alternatively incorporates the selected words and in such a way that only the selected words distinguish text of the repeating sentence within separate instances of the repeating sentence of the reading book.

6. A method as recited in claim 4, wherein the reading book includes a plurality of separate sentences that each incorporate a different one of the selected words.

7. A method as recited in claim 1, wherein the learning materials include labels, flashcards, a reading book, and a workbooks, and wherein the method includes selecting a package of learning materials to be personalized that includes the labels, flashcards, reading book and the workbook, wherein the flashcards, labels, reading book and workbook are all personalized to include a same set of personalized images of the child and corresponding selected words, and wherein the workbook further includes, for each image and selected word, a workspace for containing at least one of writing and drawing corresponding to each selected word.

8. A method as recited in claim 1, wherein act of creating the learning materials to include the selected words and the corresponding personalized images of the child includes assembling the corresponding personalized images on materials that have the selected words printed on them.

9. A method as recited in claim 8, wherein the assembling is performed prior to printing the learning materials.

10. A method as recited in claim 9, wherein the assembling is performed by a third party that is different than a consumer of the learning materials.

11. A method as recited in claim 1, wherein each of the personalized images comprise photographs that include the child.

12. A method as recited in claim 1, wherein the selected words comprise printed text words.

13. A method implemented in a computing system for personalizing learning materials, comprising:
providing client access to an interface for selecting learning materials to be personalized;
receiving a client selection of learning materials to be personalized;
identifying a list of words to be learned by a child;
for each of the selected words, identifying personalized images of the child that directly correspond to the selected words;
creating learning materials that include the selected words and personalized images of the child; and
sending the learning materials to the client.

14. A method as recited in claim 13, wherein the act of creating the learning materials includes printing the learning materials with both the selected words and the corresponding personalized images.

15. A method as recited in claim 13, wherein the act of sending the learning materials to the client includes sending the learning materials to the client in an electronic format.

16. A method as recited in claim 13, wherein the act of sending the learning materials to the client includes sending the learning materials in a printed format.

17. A method as recited in claim 13, wherein the method includes providing the client a variety of different packages of learning materials to be personalized and that can each be selected and personalized with a same set of identified words and personalized images.

18. A computer program product comprising one or more computer-readable media storing computer-executable instructions for implementing the method recited in claim 13.

19. A kit of personalized learning materials that include words to be learned by a child and corresponding personalized images of the child, wherein the kit of personalized learning materials is created in response to execution of a method comprising:
providing client access to an interface for selecting learning materials to be personalized;
receiving a client selection of learning materials to be personalized;
identifying a list of words to be learned by a child;
for each of the selected words, identifying personalized images of the child that directly correspond to the selected words; and
creating learning materials that include the selected words and personalized images of the child.

20. A kit of personalized learning materials as recited in claim 19, wherein the kit of personalized learning materials includes labels that include the selected words and the personalized images of the child.

21. A kit of personalized learning materials as recited in claim 19, wherein the kit of personalized learning materials includes labels and flashcards that each includes a same set of the selected words and the personalized images of the child.

22. A kit of personalized learning materials as recited in claim 19, wherein the kit of personalized learning materials includes labels, flashcards and a reading book that each includes a same set of the selected words and the personalized images of the child.

23. A kit as recited in claim 22, wherein the reading book includes a sentence that is repeatedly printed in the book and that alternatively incorporates the selected words and in such a way that only the selected words distinguish text of the repeating sentence within separate instances of the repeating sentence of the reading book.

24. A kit as recited in claim 22, wherein the reading book includes a plurality of separate sentences that each incorporate a different one of the selected words.

25. A kit of personalized learning materials as recited in claim 19, wherein the kit of personalized learning materials includes labels, flashcards, a reading book and a workbook that each includes a same set of the selected words and the personalized images of the child.

26. A kit of personalized learning materials as recited in claim 25, wherein the workbook further includes, for each image and selected word, a designated workspace where the child can at least one of write and draw and that is visually proximate said image and selected word.
